(19) United States
(12) Patent Application Publication
(10) Pub. No.: US 2011/0111292 A1
(43) Pub. Date: May 12, 2011

(54) ELECTRODE COMPOSITION FOR INKJET PRINTING, AND ELECTRODE AND SECONDARY BATTERY PREPARED USING THE ELECTRODE COMPOSITION

(75) Inventors: Moon-seok KWON, Hwaseong-si (KR); Han-su Kim, Seoul (KR); Jae-man Choi, Hwaseong-si (KR); Young-sin Park, Suwon-si (KR); Min-sang Song, Seongnam-si (KR)

(73) Assignee: Samsung Electronics Co., Ltd., Suwon-si (KR)

(21) Appl. No.: 12/868,959

(22) Filed: Aug. 26, 2010

(30) Foreign Application Priority Data
Nov. 12, 2009 (KR) 10-2009-0109183

(51) Int. Cl. H01B 1/20; H01M 4/02

(52) U.S. Cl. 429/209; 252/500

(57) ABSTRACT

An electrode composition for inkjet printing includes an electrode active material, a binder resin, and a solvent. An electrode and a secondary battery prepared by using the electrode use the printed electrode composition. A precise electrode pattern is formed by using an inkjet printing method since spreadability of the electrode composition is excellent. The secondary battery is a micro-thin type having increased electrode capacity and increased cycle lifespan which is prepared since coherence between the electrode composition and a current collector is excellent.

### CROSS-REFERENCE TO RELATED APPLICATION

This application claims the benefit of Korean Patent Application No. 10-2009-0109183, filed Nov. 12, 2009 in the Korean Intellectual Property Office, the disclosure of which is incorporated herein in by reference.

### BACKGROUND

1. Field

The present disclosure relates to electrode compositions for inkjet printing, and electrodes and lithium batteries prepared using the electrode compositions, and more particularly, to electrode compositions for inkjet printing having excellent spreadability and excellent coherence to a current collector, and electrodes and lithium batteries prepared using the electrode composition.

2. Description of the Related Art

Recently, secondary batteries are being increasingly used as power supply sources for mobile electronic devices, such as mobile phones, personal digital assistants (PDAs), and mobile multimedia players (PMPs). Secondary batteries are also being used for power supply sources for driving motors of hybrid cars for high output and electric cars, and power supply sources for flexible displays, such as e-inks, e-papers, flexible liquid crystal displays (LCDs), and flexible organic light emitting diodes (OLEDs). In addition, there is an increasing possibility of the secondary batteries being used as power supply sources of integrated circuit devices on printed circuit boards in the future.

However, when secondary batteries are used as power supply sources for mobile electronic devices, the design of the mobile electronic devices may be restricted to account for packaging of the secondary batteries for safety. When used as power supply sources for driving motors, there is a need for the secondary batteries to have a high output, to be miniaturized, and to be lightweight. When used as power supply sources for flexible displays, the secondary batteries are prepared to be thin, lightweight, and flexible. When used as power supply sources for integrated circuit devices, the secondary batteries are to be precisely patterned in uniform shapes.

An inkjet printing method has come into the spotlight as a method of preparing an electrode for satisfying various requirements of secondary batteries, and is a replacement for a slurry coating method. An electrode of a secondary battery prepared by using the inkjet printing method may be thin, uniform, and flat, and a desired pattern may be economically prepared by using the inkjet printing method.

A composition of an electrode of a secondary battery mainly includes an electrode active material (such as a lithium transition metal oxide), a conductive particle, a solvent used as a medium, and a binder resin combining the electrode composition and a current collector after the solvent is dried. Here, the binder resin may be selected based on dispersibility of the electrode active material and the conductive particle in the electrode composition, ejection characteristics of the electrode composition, and coherence between the electrode composition and the current collector. A solution in which polyvinylidene difluoride (PVDF) is dissolved in N-methyl-2-pirrolydone (NMP) is generally used as the binder resin. However, when PVDF is used, the coherence between the current collector, which constitutes a support, and the electrode active material does not increase. Accordingly, when the secondary battery is repeatedly charged and discharged, the electrode active material may separate from the current collector, and thus the cycle lifespan of the secondary battery is decreased. Also, the solution in which PVDF is dissolved in NMP does not have good spreadability, and thus when the electrode composition is coated on the current collector a plurality of times, electrical and mechanical connections of the secondary battery may be decreased.

### SUMMARY

Provided are electrode compositions for preparing an electrode having increased cycle lifespan, by using an inkjet printing method.

Provided are electrodes and secondary batteries prepared using the electrode compositions.

According to an aspect of the present invention, an electrode composition for inkjet printing, the electrode composition including: an electrode active material; a solvent; and a binder resin, wherein the binder resin includes a polyimide-based resin, and viscosity of the electrode composition is from about 0.5 mPa·sec to about 100 mPa·sec at a temperature of 25° C. and at a shear rate of 1000 s⁻¹.

According to an aspect of the invention, a contact angle formed by the electrode composition may be about 30° or below.

According to an aspect of the invention, the polyimide-based resin may include polyamide imide, poly ether amide imide, poly ether imide, poly ether imide ester, or any mixtures thereof.

According to an aspect of the invention, the amount of the binder resin may be from about 0.05 wt % to about 2 wt % based on the total weight of the electrode composition.

According to an aspect of the invention, the amount of the polyimide-based resin may be from about 40 wt % to about 100 wt % based on the total weight of binder resin.

According to an aspect of the invention, the amount of the electrode active material may be from about 0.01 to about 15 wt % based on to the total weight of the electrode composition.

According to another aspect of the present invention, an electrode for a secondary battery, the electrode prepared by printing the electrode.

According to another aspect of the present invention, a secondary battery including the electrode.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a contact angle between an electrode composition and a substrate;

FIG. 2 is an image of a result obtained by inkjet-discharging an electrode composition prepared according to Example 1; and

FIG. 3 is an image of a result obtained by inkjet-discharging an electrode composition prepared according to Comparative Example 1.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An electrode composition for inkjet printing according to an embodiment of the present invention includes an electrode active material, a solvent, and a binder resin. The binder resin includes a polyimide-based resin. The viscosity of the electrode composition is from about 0.5 mPa·sec to about 100 mPa·sec at a temperature of 25° C. and at a shear rate of 1000 s⁻¹.

Generally, when a polyvinylidene difluoride (PVDF) resin is used as a binder resin in an electrode composition for a secondary battery, the electrode capacity and the lifespan of the secondary battery are low since coherence between the electrode composition and a current collector constituting a support is low. Accordingly, when an electrode is formed by inkjet-printing the electrode composition in minute drops tens through hundreds of times by using the PVDF resin as the binder resin, a coherence network and a conductive network of the electrode composition or between the electrode composition and the current collector are weak. As a result, the electrode capacity and lifespan deteriorate.

A contact angle between the electrode composition and the current collector is reduced by using the polyimide-based resin, according to an embodiment of the present invention. Thus, the spreadability of the electrode composition is increased. Accordingly, the coherence and conductive networks between the electrode composition and the current collector are strong. As a result, the electrode capacity and cycle lifespan of the secondary battery are increased.

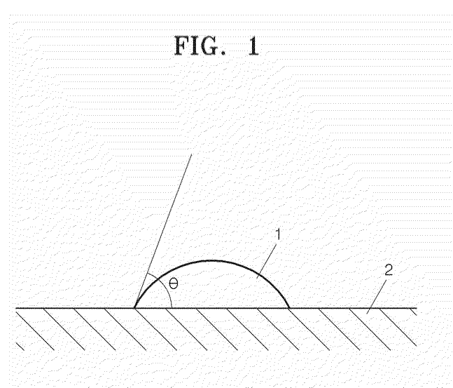

A contact angle θ between the electrode composition and an aluminum current collector may be 30° or below. Here, as shown in FIG. 1, the contact angle θ may denote an angle formed by a surface 2 of the current collector and a tangent line of a droplet surface 1 of the electrode composition.

When an electrode is formed by printing the electrode composition according to an inkjet printing method, the electrode composition is repeatedly adhered on an electrode substrate in minute drop units and dried. Here, an electrode structure is formed in the minute drop units, and the electrode structures in all the minute drop units are connected to each other as processes of evaporating the solvent in the electrode composition from the electrode structures and drying the electrode structures are repeated.

In the inkjet printing method, the connections between the electrode structures are strong in the minute drop units. However, the connections between the electrode structures when dried at different points of time are relatively weak. In other words, according to the inkjet printing method, there may exist several electrode structures weakly connected, and thus the electrical and mechanical connections of the secondary battery may deteriorate.

Accordingly, it is important to increase the spreadability of the electrode composition by reducing contacting areas between the minute droplets. The electrode composition according to the current embodiment of the present invention has good spreadability on the current collector since the contact angle θ is small. In other words, when the PVDF resin is used as a binder resin, the spreadability of the electrode composition is low since the contact angle between the electrode composition and the current collector is big. Thus, the characteristics of the electrode deteriorate when the electrode is formed by using the inkjet printing method.

In contrast, when the polyimide-based resin is used as the binder resin, the contact angle θ is small. Thus, the spreadability of the electrode composition is increased. Accordingly, the coherence and conductive networks between the electrode composition and the current collector are strong. As a result, an electrode can be prepared which has an excellent electrode capacity and cycle lifespan.

In other words, when the contact angle θ between the electrode composition and the current collector is small, the minute droplets of the electrode composition spread over the current collector and are connected to each other after being printed. Further, the electrode structures in the minute droplets are formed having a thin and wide film form. Accordingly, the electrical and mechanical connections of the electrode increase, and as a result, electrochemical performance of the electrode increases.

The electrode composition according to the current embodiment of the present invention may be used to prepare an electrode of a thin and wide secondary battery by printing the electrode composition by using an inkjet printing method.

The electrode composition has a viscosity within a printable viscosity range, and thus may be printed. In particular, the electrode composition uses the polyimide-based resin as the binder resin, and thus has excellent spreadability by decreasing the contact angle θ between the electrode composition and the current collector.

While not required in all aspects, the polyimide-based resin may include polyamide imide, poly ether amide imide, poly ether imide, poly ether imide ester, or any mixtures thereof.

While not required in all aspects, the electrode composition may use the polyimide-based resin mixed with another binder resin. Further, while not required in all aspects, where there is a combination of binder resins, the amount of the polyimide-resin may be from about 40 to about 100 wt % based on the total weight of the binder resins.

Examples of the binder resin that may be mixed with the polyimide-based resin include, but are not limited to, polyvinyl alcohol, a terpolymer of ethylene-propylene-diene, styrene-butadiene rubber, polyvinylidenefluoride or polyvinylidene difluoride (PVDF), polytetrafluoroethylene (PTFE), tetrafluoroethylene-hexafluoropropylene copolymer, carboxymethylcellulose, and any mixtures thereof. In particular, the well known binder resin may be PVDF.

While not required in all aspects, the amount of the binder resin may be from about 0.05 to about 2 wt % based on the total weight of the electrode composition.

In the electrode composition, the electrode active material is not specifically limited. For instance, the electrode active material may be any one of a positive electrode active material and a negative electrode active material generally used as an electrode active material of a secondary battery. Examples of the positive electrode active material include, but are not limited to, a lithium-cobalt (Li—Co)-based composite oxide such as LiCoO₂, a lithium-nickel (Li—Ni)-based composite oxide such as LiNiO₂, a lithium-manganese (Li—Mn)-based composite oxide such as LiMn₂O₄ or LiMnO₂, a lithium-chromium (Li—Cr)-based composite oxide such as Li₂Cr₂O₇ or Li₂CrO₄, a lithium-iron (Li—Fe)-based composite oxide such as LiFePO₂, and a lithium-vanadium (Li—V)-based composite oxide. Examples of the negative electrode active material include, but are not limited to, a lithium-titanium (Li—Ti)-based composite oxide such as Li₄Ti₅O₁₂, a transition metal oxide such as SnO₂, In₂O₃ or Sb₂O₃, a metal such as silicon (Si), and a carbon-based material such as graphite, hard carbon, acetylene black, or carbon black.

The amount of the electrode active material may be from about 0.01 wt % to about 15 wt % based on the total weight of the electrode composition. The viscosity of the electrode composition is not high within this range. Thus, the stability and ink ejectability of the electrode composition are excellently maintained, thereby increasing printing efficiency of the electrode composition.

In the electrode composition according to the current embodiment of the present invention, the solvent is not specifically limited. Examples of the solvent include: saturated hydrocarbons such as hexane; aromatic hydrocarbons such as toluene or xylene; alcohols such as methanol (MeOH), ethanol (EtOH), propanol (PrOH), or butanol (BuOH); ketones such as acetone, methylethylketone (MEK), methylisobutylketone (MIBK), or diisobutylketone; esters such as ethyl acetate or butyl acetate; ethers such as tetrahydrofuran (THF), dioxane, or diethylether; dimethylsulfoxide (DMSO), dimethylacetamide (DMAC), dimethylformamide (DMF), N-methylpyrrolidone, water, and any mixtures thereof.

The amount of the solvent may be from about 80 wt % to about 99.5 wt % based on the weight of the electrode composition. The viscosity of the electrode composition is not high within this range. Thus, the stability and ink ejectability of the electrode composition are excellently maintained, thereby increasing the printing efficiency of the electrode composition.

According to another embodiment of the present invention, the electrode composition may further include at least one of a conducting agent, a moisturizer, a dispersing agent, and a buffer. The conducting agent may be used to increase conductivity of particles of the electrode active material. The conducting agent is not specifically limited. Examples of the conducting agent include, but are not limited to, acetylene black, carbon black, graphite, carbon fibers, and carbon nano-tubes. The amount of the conducting agent may be from about 0.01 wt % to about 5 wt % based on the weight of the electrode composition, but is not limited thereto.

The moisturizer may be used to prevent a nozzle for ejecting the electrode composition from being blocked due to drying of the electrode composition at the nozzle. The moisturizer may be, for example, glycols, glycerols, or pyrrolidones. The amount of the moisturizer may be from about 5 wt % to about 40 wt % based on the weight of the electrode composition. However, the moisturizer need not be used in all aspects, such as where the electrode composition may not dry in the nozzle due to the amount of the solvent used.

The dispersing agent may be used to disperse the electrode active material and the conducting agent. Examples of the dispersing agent are not specifically limited. Specifically, the dispersing agent may be at least one type selected from the group consisting of general dispersing agents, such as a fatty acid salt, an alkyl dicarboxylic acid salt, an alkyl sulfuric acid ester salt, a polyvalent sulfuric acid ester alcohol salt, an alkylnaphthalene sulfuric acid salt, an alkylbenzene sulfuric acid salt, an alkylnaphthalene sulfuric acid ester salt, an alkylsulfone succinic acid salt, a naphthenic acid salt, an alkylether carboxylic acid salt, an acylated peptide, an alpha-olefin sulfuric acid salt, an N-acylmethyltaurine salt, an alkylether sulfuric acid salt, a secondary polyvalent alcohol ethoxy sulfate, a polyoxyethylene alkyl permylether sulfuric acid salt, monoglysulfate, an alkyl ether phosphoric acid ester salt, an alkyl phosphoric acid ester salt, an alkylamine salt, an alkylpyridium salt, an alkylimidazolium salt, a fluorine based- or silicon based-acrylic acid polymer, a polyoxyethylene alkyl ether, a polyoxyethylene sterol ether, lanolin derivatives of polyoxyethylene, a polyoxyethylene/polyoxypropylene copolymer, a polyoxyethylene sorbitan fatty acid ester, a monoglyceride fatty acid ester, a sucrose fatty acid ester, an alkanol amide fatty acid, a polyoxyethylene fatty acid amide, a polyoxyethylene alkyl amine, polyvinyl alcohol, polyvinylpyridone, a polyacrylamide, a carboxylic group-containing aqueous polyester, a hydroxyl group-containing cellulose based resin, an acryl resin, butadiene resin, acrylic acids, styrene acryls, polyesters, polyamides, polyurethanes, alkyl betamine, an alkyl amine oxide, and phosphatidylcholine.

The amount of the dispersing agent may be from about 1 wt % to about 20 wt % based on the weight of the electrode composition. The dispersing agent need not be used in all aspects considering the characteristics and dispersibility of electrode composition.

The buffer may be used so as to adjust the pH of the electrode composition to a suitable level while maintaining the stability of the electrode composition. The buffer may be at least one type selected from the group consisting of amines such as trimethylamine, triethanolamine, diethanolamine, and ethanolamine, sodium hydroxide, and ammonium hydroxide. The amount of the buffer may be from about 0.1 wt % to about 5 wt % based on the weight of the electrode composition. The buffer need not be used in all aspects depending on the characteristics of the electrode composition.

The electrode composition may be in an ink form and used in the inkjet printing method. Accordingly, the electrode composition is prepared by mixing and dispersing suitable amounts of the electrode active material, the solvent, the binder resin, the moisturizer, the conducting agent, the dispersing agent, the buffer, and the like.

Here, by adjusting the amounts of the electrode active material, the binder resin, and the solvent, the electrode composition may be obtained which has a viscosity within an inkjet-printable range.

The electrode composition obtained as above may be used to form an electrode by printing the electrode composition on a current collector in a predetermined pattern by using an inkjet printer. While not limited thereto, the pattern can be formed of drop units printed onto the current collectors where an intermediate value of particle diameters D₅₀ of the electrode active material may be from about 50 nm to about 500 nm.

According to the inkjet printing method, the electrode composition is printed on the current collector in droplets from a nozzle of the inkjet printer. The inkjet printing method may be a thermal inkjet printing method or a piezoelectric printing method. The piezoelectric printing method may be used considering the thermal stability of materials of a secondary battery to be manufactured. A positive electrode may be formed by printing the electrode composition including the positive electrode active material using the inkjet printing method, and a negative electrode may be formed by printing the electrode composition including the negative electrode active material using the inkjet printing method.

A method of printing the electrode composition using an inkjet printing method is not specifically limited. For example, the electrode composition may be printed on the current collector in a predetermined pattern by using proper software, after connecting an inkjet printer using an inkjet head to a commercial computer. The electrode composition printed on the current collector may be dried at a temperature from about 20° C. to about 200° C. for from about 1 minute to about 8 hours at a vacuum state or in the air, but the conditions for drying the electrode composition are not limited thereto. The current collector may be formed of a well known material. For example, the current collector may be an aluminum thin film, a stainless thin film, a copper thin film, or a nickel thin film.

The electrode composition described above has excellent spreadability when printed according to the inkjet printing method. Thus, the cohesion and conductive networks between the electrode composition and the current collector are strong, thereby increasing the electrode capacity and cycle lifespan of the electrode.

Also, by forming the electrode with a high resolution and high precision pattern, it is possible to prepare a thin micro secondary battery that may be used as a power supply source of an integrated circuit device. Further, it is possible to prepare a secondary battery having a 3-dimensional (3D) electrode pattern. However, the type of battery which can use the formed electrode is not specifically limited.

A secondary battery according to an embodiment of the present invention includes the electrode prepared by printing the electrode composition according to the inkjet printing method. The electrode is not specifically limited to any one type, and may be a stacked-type, a jelly roll type, etc. Also, the electrode may be used in a lithium primary battery, a lithium secondary battery, or a fuel cell.

A method of preparing the secondary battery is not specifically limited as long as the electrode prepared by printing the electrode composition according to the inkjet printing method is used. Also, the electrode composition may be used to prepare one of a positive electrode and a negative electrode, or both the positive electrode and negative electrode.

For example, the positive electrode may be formed by printing the electrode composition on the current collector by using the inkjet printing method, and drying the electrode composition. The negative electrode may be formed by printing the electrode composition on the current collector, that is, on a side opposite to the positive electrode, by using the inkjet printing method, and drying the electrode composition. As such, a bipolar electrode is formed.

An electrolyte layer having a predetermined thickness is formed on at least one of the positive electrode and negative electrode of the bipolar electrode, and then dried. The bipolar electrodes, on which the electrolyte layer is formed, are stacked on each other in an inert atmosphere so as to prepare an electrode assembly. An insulating sealing layer is formed on the electrode assembly, and then the electrode assembly is packed so as to complete a secondary battery.

Hereinafter, one or more embodiments of the present invention will be described in detail with reference to the following examples. However, these examples are not intended to limit the purpose and scope of the one or more embodiments of the present invention.

### Example 1

A solution including 4 parts by weight of nano-size Li₄Ti₅O₁₂ (manufactured by nGimat), 0.5 parts by weight of ketjen black, 0.5 parts by weight of polyamideimide (PAI) (manufactured by Solvay), and a small amount of N-methyl-2-pyrrolidone (NMP) was prepared. The NMP solvent was added to the solution so that the amount of the solvent was 95 parts by weight, and the solution was processed with ultrasonic waves for 2 hours, thereby preparing an electrode composition.

To prepare an electrode, the electrode composition was repeatedly printed on an aluminum foil in a pattern having a circular shape and a thickness of the active material layer was 5 μm or above using an inkjet printer (Dimatix DMP-2831). At this time, ink ejectability of the electrode composition was evaluated.

The viscosity of the electrode composition was measured at a temperature of 25° C. at a shear rate of 1000 s⁻¹ by using AR-2000 (TA Instrument).

A contact angle formed by the electrode composition was measured by dropping one drop of the electrode composition on a flat aluminum foil (Samjin Cooking Foil, manufactured by Samjin Silver Foil) having a thickness of 16 μm by using a 19 G needle (manufactured by Korea Vaccine Co.). The contact angle is measured by using a contact angle measurer (DGD-DI, manufactured by GBX).

The electrode was dried in a vacuum oven at a temperature of 120° C., and a coin cell was prepared by using a lithium metal as a counter electrode. Then, the coin cell was repeatedly charged and discharged by using a charger and discharger (manufactured by TOYO) in the range of 1.2 V to 2.5 V and a current of 0.1 C, so as to evaluate initial capacity and 7th cycle lifespan. The ink ejectability, the viscosity, the contact angle, the initial capacity, and the 7^{th} cycle lifespan are shown in Tables 1 and 2 below.

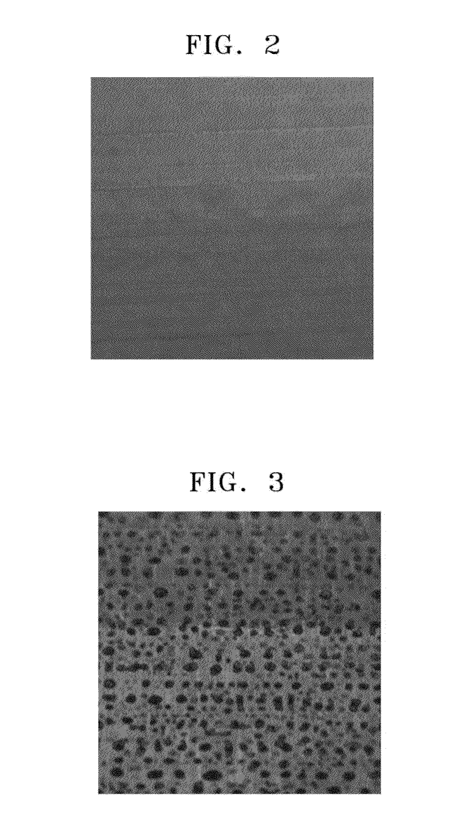

FIG. 2 is an image of a negative electrode obtained by ejecting the electrode composition prepared according to Example 1 by using an inkjet printer. As shown in FIG. 2, a wide film type active material layer is formed as the electrode composition spreads on the current collector.

### Examples 2 Through 5

An electrode composition was prepared in the same manner as Example 1, except that a binder resin, an electrode active material, a conducting agent, and a solvent were used in the composition as shown in Tables 1 and 2. Then, an electrode and a coin cell prepared by using the electrode composition were evaluated and results of the evaluation are shown in Tables 1 and 2.

### Comparative Examples 1 Through 3

An electrode composition was prepared in the same manner as Example 1, except that a binder resin, an electrode active material, a conducting agent, and a solvent were used in the composition as shown in Tables 1 and 2. Then, an electrode and a coin cell prepared by using the electrode composition were evaluated and results of the evaluation are shown in Tables 1 and 2.

FIG. 3 is an image of a negative electrode obtained by ejecting the electrode composition prepared according to Comparative Example 1 by using an inkjet printer. As shown in FIG. 3, an active material layer is formed as the electrode composition printed on a current collector is formed in droplets, instead of being spread on the current collector.

TABLE 1

| | Binder Resin | | Active Material | Conducting | | NMP | |
|---|---|---|---|---|---|---|---|
| | (wt %) | | (wt %) | Agent (wt %) | | Solvent | Total |
| | PAI | PVDF | LTO | Ketjen Black | Super P | (wt %) | (wt %) |
| Example 1 | 0.5 | — | 4 | 0.5 | — | 95 | 100 |
| Example 2 | 0.25 | 0.25 | 4 | 0.5 | — | 95 | 100 |
| Example 3 | 0.25 | — | 4.5 | 0.25 | — | 95 | 100 |
| Example 4 | 0.5 | — | 8 | 0.5 | — | 91 | 100 |
| Example 5 | 0.5 | — | 4 | — | 0.5 | 95 | 100 |
| Comparative | — | 0.5 | 4 | — | 0.5 | 95 | 100 |
| Example 1 | | | | | | | |
| Comparative | 7.5 | — | 4 | 0.5 | — | 88 | 100 |
| Example 2 | | | | | | | |
| Comparative | 0.5 | — | 29 | 0.5 | — | 70 | 100 |
| Example 3 | | | | | | | |

TABLE 2

| | Contact | Ink | Initial Capacity | Initial | 7^{th} Cycle | Viscosity |
|---|---|---|---|---|---|---|
| | Angle (°) | Ejectability | (mAh/g) | Efficiency (%) | Lifespan | (mPa · s) |
| Example 1 | 15.3 | Good | 168.1 | 74.2 | 95.8 | 4.88 |
| Example 2 | 16.1 | Good | 150.3 | 80.9 | 91.7 | 4.00 |
| Example 3 | 27.6 | Good | 147.1 | 81.4 | 93.0 | 5.11 |
| Example 4 | 24.8 | Good | 162.5 | 84.0 | 95.2 | 4.40 |
| Example 5 | 18.3 | Good | 136.1 | 76.2 | 93.6 | 4.21 |
| Comparative | 31.3 | Good | 39.5 | 28.6 | 29.0 | 3.86 |
| Example 1 | | | | | | |
| Comparative | 42.4 | Ejection | — | — | — | 287 |
| Example 2 | | Impossible | | | | |
| Comparative | 48.3 | Ejection | — | — | — | 521 |
| Example 3 | | Impossible | | | | |

Referring to Tables 1 and 2, and FIGS. 2 and 3, the electrode composition according to the embodiments of the present invention may be used to prepare an electrode having an excellent precise pattern by using an inkjet printing method, since the ejectability of the electrode composition is excellent. Also, the electrode has excellent electrode capacity and excellent lifespan since the electrode composition has excellent spreadability and excellent coherence to a support.

As described above, according to the one or more of the above embodiments of the present invention, the electrode composition has excellent spreadability and excellent coherence to a support, and thus when the electrode composition is printed by using an inkjet method, an electrode having increased capacity and lifespan may be prepared.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrode composition for inkjet printing, the electrode composition comprising:
an electrode active material;
a solvent; and
a binder resin comprising a polyimide-based resin,
wherein a viscosity of the electrode composition is from about 0.5 mPa·sec to about 100 mPa·sec at a temperature of 25° C. and at a shear rate of 1000 s⁻¹.

2. The electrode composition of claim 1, wherein a contact angle formed by the electrode composition on a surface is greater than zero and about 30° or below.

3. The electrode composition of claim 1, wherein the polyimide-based resin comprises polyamide imide, poly ether amide imide, poly ether imide, poly ether imide ester, or any mixtures thereof.

4. The electrode composition of claim 1, wherein an amount of the binder resin is from about 0.05 wt % to about 2 wt % based on a total weight of the electrode composition.

5. The electrode composition of claim 1, wherein an amount of the polyimide-based resin in the binder resin is from about 40 wt % to about 100 wt % based on a total weight of the binder resin.

6. The electrode composition of claim 1, wherein an amount of the electrode active material is from about 0.01 to about 15 wt % based on to a total weight of the electrode composition.

7. The electrode composition of claim 1, wherein the solvent comprises dimethylacetamide, dimethylformamide, N-methylpyrrolidone, dimethyl sulfoxide, or any mixtures thereof.

8. The electrode composition of claim 1, wherein an amount of the solvent is from about 80 wt % to about 99.5 wt % based on a total weight of the electrode composition.

9. The electrode composition of claim 1, further comprising at least one component comprises a conducting agent, a moisturizer, a dispersing agent, a buffer, or combinations thereof.

10. The electrode composition of claim 9, wherein the at least one component comprises the conducting agent, and an amount of the conducting agent is from about 0.01 wt % to about 5 wt % based on a total weight of the electrode composition.

11. An electrode for a secondary battery, the electrode being prepared by printing an electrode composition on a current collector, the electrode composition comprising:
an electrode active material;
a solvent; and
a binder resin comprising a polyimide-based resin,
wherein a viscosity of the electrode composition is from about 0.5 mPa·sec to about 100 mPa·sec at a temperature of 25° C. and at a shear rate of 1000 s⁻¹.

12. A secondary battery comprising the electrode of claim 11.
